(19) United States
(12) Patent Application Publication
(10) Pub. No.: US 2018/0164041 A1
(43) Pub. Date: Jun. 14, 2018

(54) MANUFACTURING METHOD OF PHASE-CHANGING HEAT DISSIPATER

(71) Applicant: Celsia Technologies Taiwan, Inc., Taoyuan County (TW)

(72) Inventors: George Anthony Meyer, IV, Morgan Hill, CA (US); Hsin-Hua WEN, Taoyuan County (TW); Ming-Kuei HSIEH, Taoyuan County (TW); Chieh-Ping CHEN, Taoyuan County (TW)

(21) Appl. No.: 15/883,054

(22) Filed: Jan. 29, 2018

Related U.S. Application Data
(62) Division of application No. 14/686,096, filed on Apr. 14, 2015.

(51) Int. Cl. F28D 15/04; B23P 15/26; B22F 3/105; B22F 5/10; B22F 5/00

(52) U.S. Cl. CPC F28D 15/04; B23P 15/26; B22F 3/1055; B22F 5/106; F28D 15/046; F28F 2275/067; B22F 2005/005; B23P 2700/09; B22F 2005/004; F28F 2255/18; Y02P 10/295

(57) ABSTRACT

The present invention relates to a phase-changing heat dissipater and a manufacturing method thereof. The heat dissipater includes a main body, a capillary structure and a working fluid. The capillary structure is composed of a plurality of metal powders being provided on an inner wall of the main body with a spraying means and processed with a sintering process for being formed thereon; and the working fluid is filled in the main body. Accordingly, the capillary structure is able to be tightly adhered in main body, thereby effectively preventing the capillary structure from being damaged and enhancing the heat conducting performance of the phase-changing heat dissipater.

### CROSS-REFERENCE TO RELATED APPLICATION

This application is a divisional application of U.S. patent application Ser. No. 14/686,096, filed on Apr. 14, 2015, and entitled “PHASE-CHANGING HEAT DISSIPATER AND MANUFACTURING METHOD THEREOF”. The entire disclosures of the above application are all incorporated herein by reference.

### BACKGROUND OF THE INVENTION

### Field of the Invention

The present invention relates to a phase-changing heat dissipater, especially to a phase-changing heat dissipater and a manufacturing method thereof.

### Description of Related Art

With the increasing calculation speed of an electronic device such as a processor, massive amount of heat is generated. For effectively dissipating the massive amount of heat, the skilled people in the art have developed a phase-changing heat dissipater having great heat conductivity such as a heat pipe or a vapor chamber; however, the heat conducting performance of the heat pipe itself, the manufacturing method and the manufacturing equipment for the heat pipe still have rooms for improvement.

A conventional manufacturing method of a heat pipe is to prepare a main body and a woven net, and the woven net is wound and disposed in the interior of the main body. According to the above-mentioned manufacturing method, the woven net disposed in the main body is unable to be tightly adhered on an inner wall of the main body, so situations such as the condensed liquid not being continuous or even delayed during the returning process may occur.

Another manufacturing method of a heat pipe is to insert a core in a main body, then metal powders are provided in a space defined by the main body and the core, and a sintering process is performed, so a capillary structure is able to be formed on an inner wall of the main body after the core is removed. This manufacturing method can solve the problem existed in the above-mentioned manufacturing method; however, during the sintering process, the sintering and solidifying may cause the core being hard to be removed from the main body, and the capillary structure may be damaged during the process of removing the core. Accordingly, the above-mentioned disadvantages causing the heat pipe to have poor heat conducting performance shall be improved.

### SUMMARY OF THE INVENTION

The present invention is to provide a phase-changing heat dissipater and a manufacturing method thereof, so a capillary structure is able to be tightly formed on an inner wall of a main body, thereby effectively preventing the capillary structure from being damaged and enhancing the heat conducting performance of the phase-changing heat dissipater.

Accordingly, the present invention provides a manufacturing method of a phase-changing heat dissipater, which includes the steps of: a step a) preparing a main body; a step b) allowing a plurality of metal powders to be provided and formed on an inner wall of the main body with a spraying means; and a step c) processing a sintering process to each of the metal powders for forming a capillary structure.

Accordingly, the present invention provides a phase-changing heat dissipater, which includes a main body, a capillary structure and a working fluid; the capillary structure is composed of a plurality of metal powders being provided on an inner wall of the main body with a spraying means and processed with a sintering process for being formed thereon; and the working fluid is filled in the main body.

In comparison with related art, the present invention has advantageous features as follows: the capillary structure is formed with a spraying means, so the manufacturing process is able to be simplified and the quality is able to be ensured; and different capillary structures with various geometric shapes can be easily formed.

### BRIEF DESCRIPTION OF DRAWING

FIG. 1 is a flowchart illustrating a manufacturing method of a phase-changing heat dissipater according to one embodiment of the present invention;

FIG. 2 is a perspective exploded view showing a phase-changing heat dissipater being assembled with a heat dissipater manufacturing equipment according to one embodiment of the present invention;

FIG. 3 is a schematic view showing the assembly of the phase-changing heat dissipater and the heat dissipater manufacturing equipment according to one embodiment of the present invention;

FIG. 4 is another schematic view showing the assembly of the phase-changing heat dissipater and the heat dissipater manufacturing equipment according to one embodiment of the present invention;

FIG. 5 is a cross sectional view showing the operating status of the phase-changing heat dissipater and the heat dissipater manufacturing equipment according to one embodiment of the present invention;

FIG. 6 is a partial schematic view showing the phase-changing heat dissipater according to one embodiment of the present invention;

FIG. 7 is a partial schematic view showing the phase-changing heat dissipater according to another embodiment of the present invention;

FIG. 8 is a perspective schematic view showing the appearance of the phase-changing heat dissipater according to one another embodiment of the present invention;

FIG. 9 is a cross sectional view showing the operating status of the phase-changing heat dissipater and the heat dissipater manufacturing equipment according to one another embodiment of the present invention;

FIG. 10 is a cross sectional view showing a heat conductive plate being formed on a surface of the phase-changing heat dissipater according to one another embodiment of the present invention;

FIG. 11 is a cross sectional view showing a plurality of heat dissipation sheets being formed on a surface of the phase-changing heat dissipater according to one another embodiment of the present invention;

FIG. 12 is a cross sectional view showing a fasten seat being formed on a surface of the phase-changing heat dissipater according to one another embodiment of the present invention; and

FIG. 13 is a cross sectional view showing the assembly of the phase-changing heat dissipater and the heat dissipater manufacturing equipment according to still one another embodiment of the present invention.

### DETAILED DESCRIPTION OF THE INVENTION

Preferred embodiments of the present invention will be described with reference to the drawings.

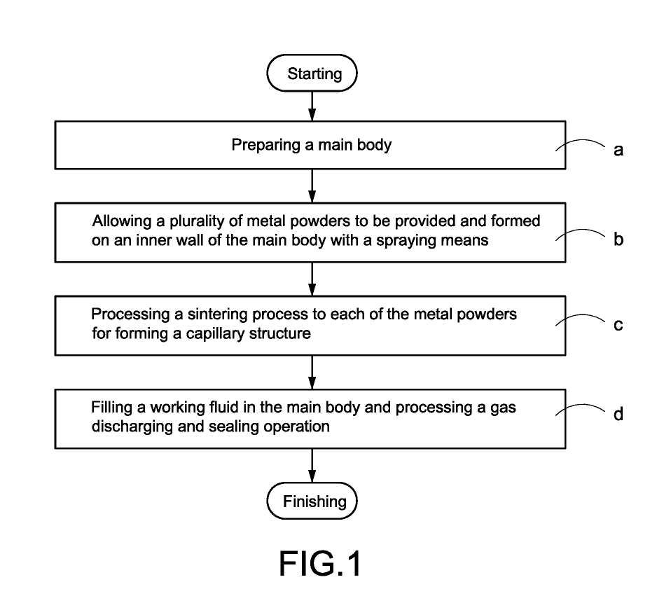

The present invention provides a phase-changing heat dissipater and a manufacturing method thereof. Please refer to FIG. 1, according to this embodiment, the phase-changing heat dissipater is a heat pipe, and the manufacturing method includes the steps of:

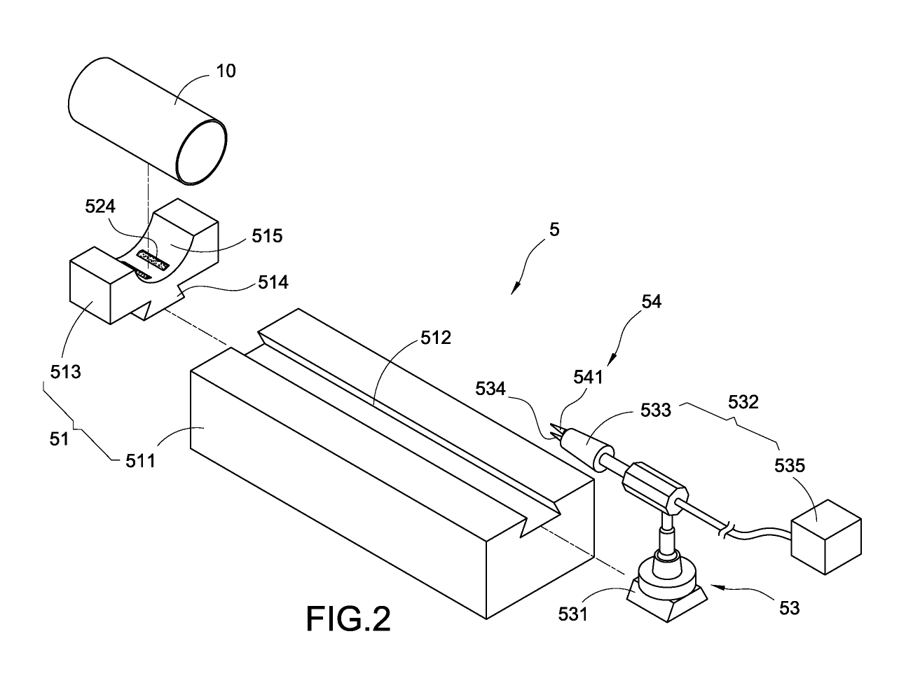

a step a) preparing a main body 10; please refer to FIG. 2, according to this step, the main body 10 is made of a metal material having great extensibility such as copper or a copper alloy, the main body 10 is substantially formed in an elongated status and the cross section thereof is formed in a circular shape.

a step b) allowing a plurality of metal powders to be provided and formed on an inner wall of the main body 10 with a spraying means;

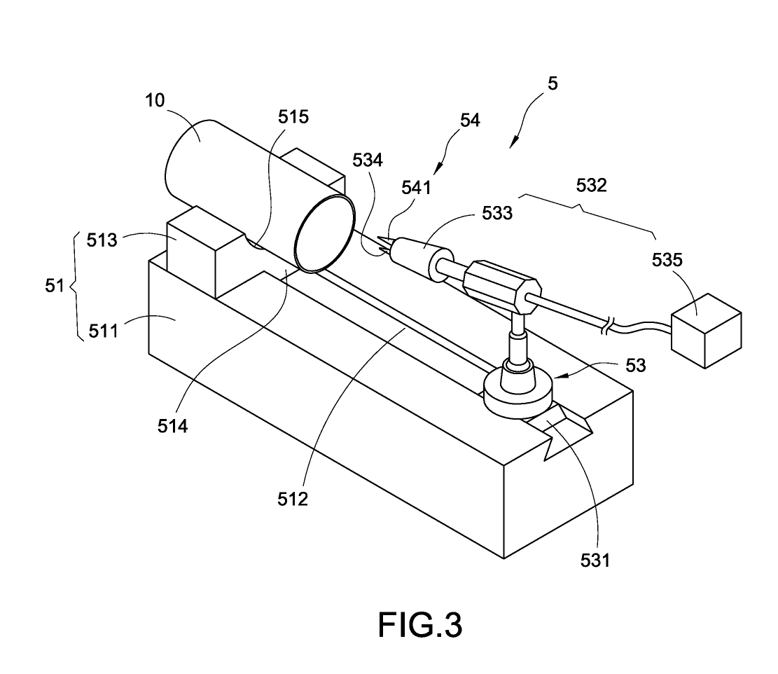

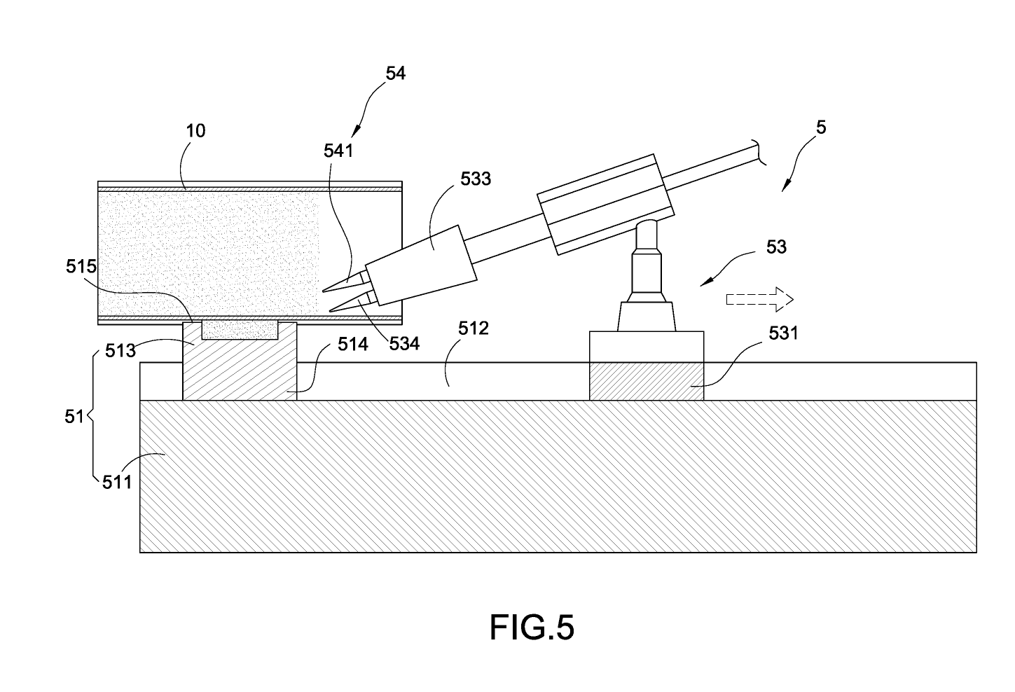

according to this step, a heat dissipater manufacturing equipment 5 is provided for the purpose of processing; please refer from FIG. 2 to FIG. 5, wherein the heat dissipater manufacturing equipment 5 includes a carrying mechanism 51, a driving mechanism 52 and a spraying mechanism 53.

The carrying mechanism 51 includes a base 511 and a carrier 513, the central portion of the base 511 is formed with a guide groove 512, and the guide groove 512 is formed in a dovetail status. The bottom end of the carrier 513 is extended with a guide block 514 matching with the guide groove 512 for being mutually mounted, and the top end of the carrier 513 is formed with a recess 515 which is in a semi-circular status.

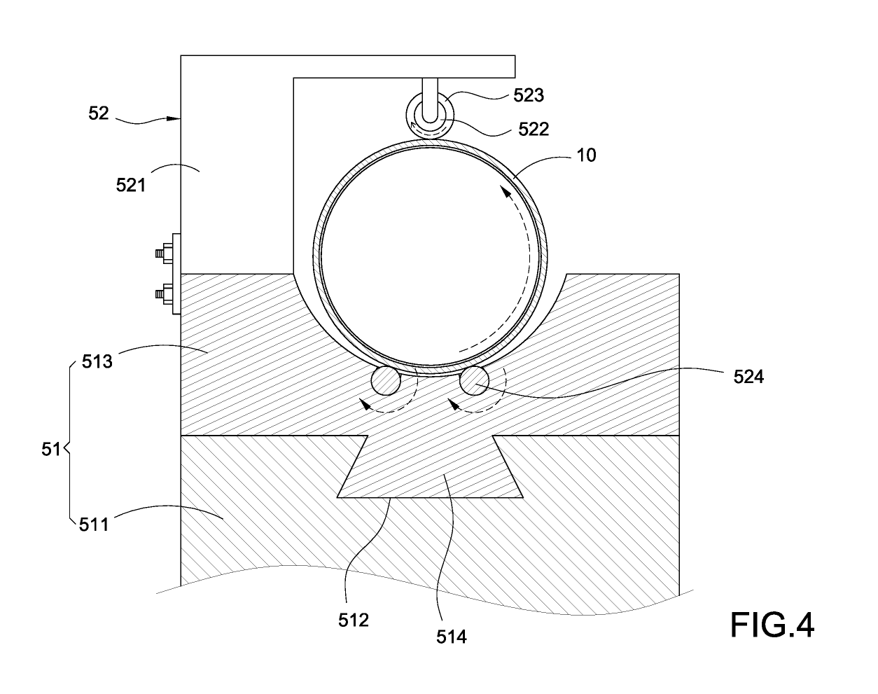

The driving mechanism 52 includes a rotary arm 521, a motor 522, an upper roller 523 and two lower rollers 524 (as shown in FIG. 4); one end of the rotary arm 521 is fastened on the carrier 513, and the other end thereof is formed on top of the recess 515; the motor 522 is connected to the upper roller 523, the motor 522 and the upper roller 523 are installed at the other end of the rotary arm 521, and the motor 522 is served to drive the upper roller 523 to rotate and the above-mentioned two components are enabled to perform an up/down movement or a front/rear swing motion relative to the rotary arm 521 thereby allowing the main body 10 to be disposed in the recess 515, and the two lower rollers 524 are disposed in the recess 515 so the main body 10 is able to be rotated through the upper roller 523 and each of the lower rollers 524.

The spraying mechanism 53 can be a three-dimension sprayer or a three-dimension printer, and includes a mobile seat 531 and a spraying set 532 connected to the mobile seat 531, wherein the mobile seat 531 is driven by a driver such as a motor (not shown in figures) so as to be freely moved towards forward or backward in the above-mentioned guide groove 512; the spraying set 532 includes a nozzle head member 533, a powder supplier 535 communicated with the nozzle head member 533 and other relevant component and device such as a controller, wherein the front end of the nozzle head member 533 is installed with a nozzle 534.

a step c) processing a sintering process to each of the metal powders for forming a capillary structure 20.

According to this step, the heat dissipater manufacturing equipment 5 further includes a sintering mechanism 54 which can be a laser sinter and provided with a laser head 541 fastened on the nozzle head member 533 of the spraying set 532.

In actual operation, the desired pattern of the capillary structure 20 to be sintered is inputted into the spraying mechanism 53, then the main body 10 is disposed between the upper roller 523 and each of the lower rollers 524, and the motor 522 is served to drive the upper roller 523 to rotate thereby enabling the rotating upper roller 523 to drive the main body 10 and each of the lower rollers 524 to rotate. At this moment, the nozzle head member 533 is protruded into the interior of the main body 10, and the nozzle 534 is enabled to spray the metal powders for being adhered on the inner wall of the main body 10 through the powder supplier 535 working with the controller, the mobile seat 531 is driven by the motor for being backwardly moved in the guide groove 511, and the laser head 541 of the sintering mechanism 54 is served to emit laser for heating and sintering the metal powders so as to form the capillary structure 20.

Wherein, the spraying means disclosed in the step b) and the sintering process disclosed in the step c) are processed to the main body 10 in stages, firstly the nozzle head member 533 is served to spray the metal powders with a certain distance or area corresponding to the lowest location defined inside the main body 10, then the laser head 541 is served to sinter the above-mentioned sprayed metal powders; after the mobile seat 531 is backwardly moved with a certain distance in the guide groove 511, the above-mentioned spraying means and the sintering process are performed again until the whole main body 10 is processed. Wherein, the spraying location being defined at the lowest location inside the main body 10 is provided with advantages of facilitating the powder stacking and preventing the powders from being loosen or fallen due to the gravity.

In addition, the spraying means disclosed in the step b) can be achieved through circumferentially spraying and axially linearly moving, wherein the circumferentially spraying is to enable the nozzle head member 533 to be fixed and served to spray powders to the whole circumference of the inner wall of the main body 10 while the main body 10 is driven to rotate by the upper roller 523 and each of the lower rollers 524; the axially linearly moving is to allow the main body 10 to be fixed and enable the nozzle head member 533 to be served to spray powders to the circumference of the inner wall of the main body 10 through the mobile seat 531 being backwardly moved in the guide groove 512; then the upper roller 523 and each of the lower rollers 524 are served to drive the main body 10 to rotate a certain angle, and the mobile seat 531 is moved for spraying powders so as to finish the whole process of powder spraying.

According the manufacturing method of the phase-changing heat dissipater provided by the present invention, a step d) is further provided after the step c), wherein the step d) is to fill a working fluid in the main body 10, and a gas discharging and sealing operation is processed.

According to the present invention, the phase-changing heat dissipater 1 manufactured by the above-mentioned manufacturing method mainly includes a main body 10, a capillary structure 20 and a working fluid (not shown in figures), wherein for increasing the adhering capability of the metal powders in the capillary structure 20, the metal powders are mixed with an adhering agent. In addition, the capillary structure 20 can be sprayed for fully covering the inner wall of the main body 10, or be sprayed for partially covering the inner wall of the main body 10, wherein the partially covering manner can allow the capillary structure 20 to be formed only at the lower semi-circular surface of the main body 10 or only formed on the inner wall defined at the front portion of the main body 10. Moreover, the capillary structure 20 cannot only be served to transport the working fluid, but also can be served as a supporting structure for the main body 10 thereby enhancing the rigidity strength.

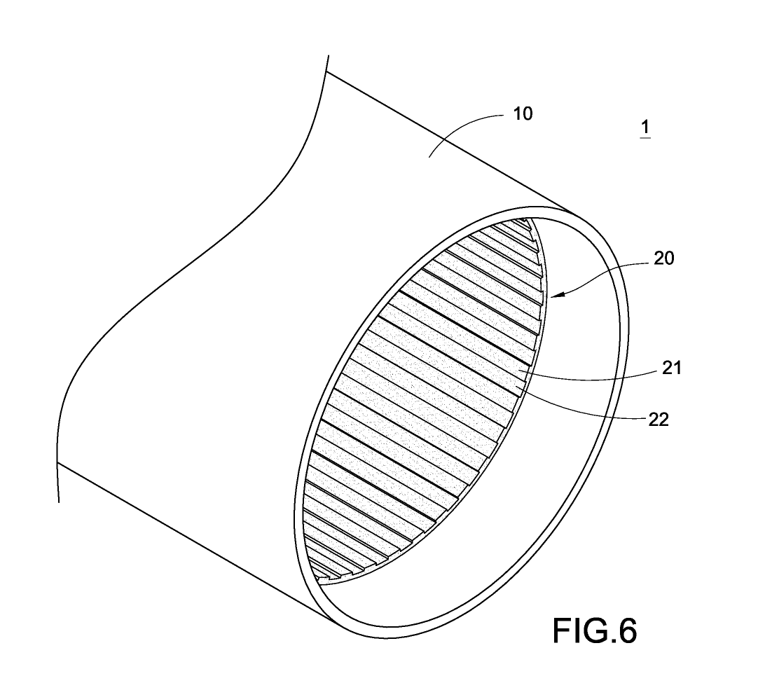

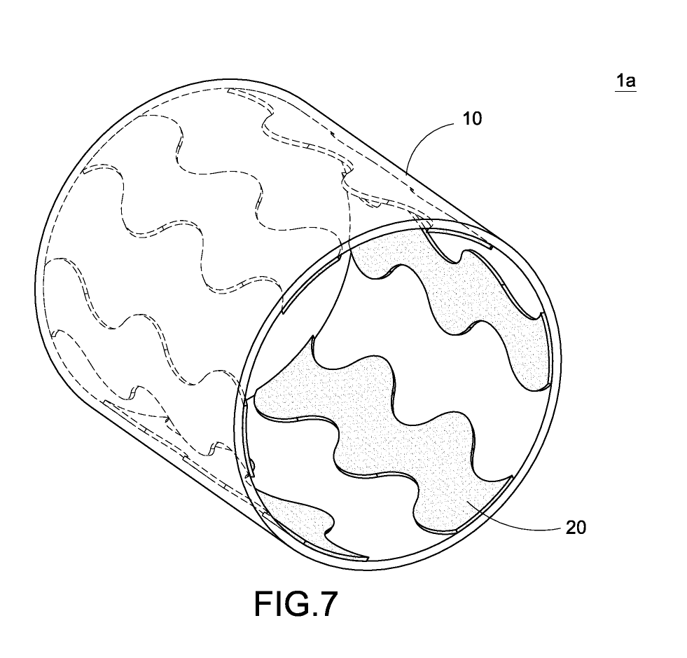

Please refer to FIG. 6 and FIG. 7, the above-mentioned capillary structure 20 can also be a three-dimensional structure formed with a plurality of ribs 21, wherein a slot 22 is formed between every two of the adjacent ribs 21, each of the slots 22 can be arranged to be in parallel to the axial core direction of the main body 10 so as to form the phase-changing heat dissipater 1 (as shown in FIG. 6). Each of the slots 22 can also be arranged to be not in parallel to the axial core of the main body 10, such as being formed as a spiral slot (not shown in figures). Also, the capillary structure 20 can be composed of a plurality of corrugated ribs (shown in FIG. 7) spaced with intervals so as to form a phase-changing heat dissipater 1a.

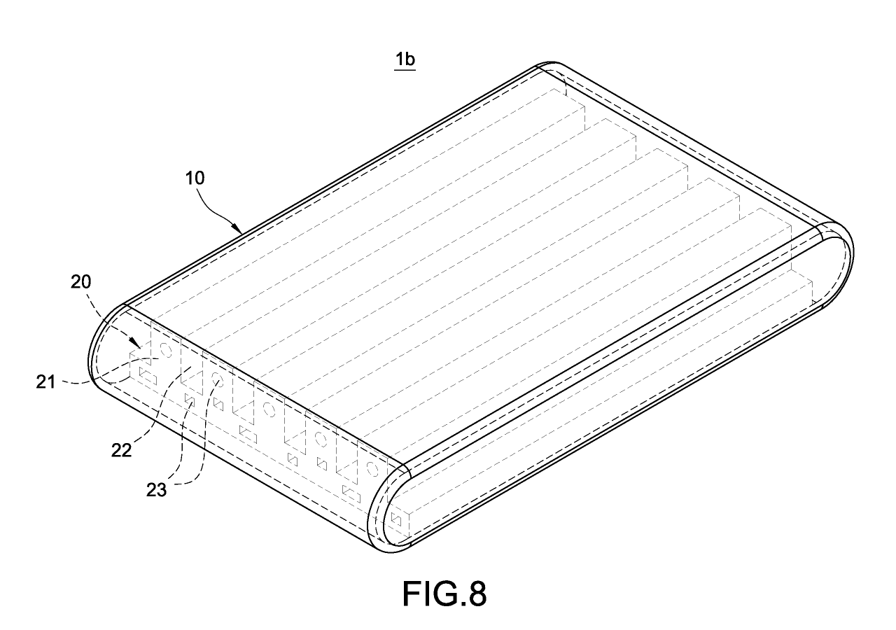

Preferably, the manufacturing method of the phase-changing heat dissipater provided by the present invention further includes a step e) which is processed after the step d), the step e) is to perform a flattening process for forming a flat phase-changing heat dissipater 1b. Please refer to FIG. 8, according to this step, the phase-changing heat dissipater 1 processed with the step d) is disposed on a platform, and a pressing machinery is used for performing the flattening process so as to form the flat phase-changing heat dissipater 1b. Wherein, the particle shape and size of each of the metal powders of the capillary structure 20 can be selected according to actual needs, in other words metal powders having the same or different particle sizes can be adopted according to the present invention. In addition, each of the ribs 21 of the capillary structure 20 can not only be formed as a solid structure, the interior thereof can also be formed with a plurality of gas tunnels 23, and the cross section of the gas tunnel 23 can be formed in circular, rectangular or other geometric shapes. Moreover, the axial length of the main body 10 is greater than the length of the capillary structure 20, thereby enabling a heat exchanging zone communicating each of the gas tunnels 23 and each of the slots 22 to be respectively formed between the distal ends of the main body 10 and the front and the rear ends of the capillary structure 20.

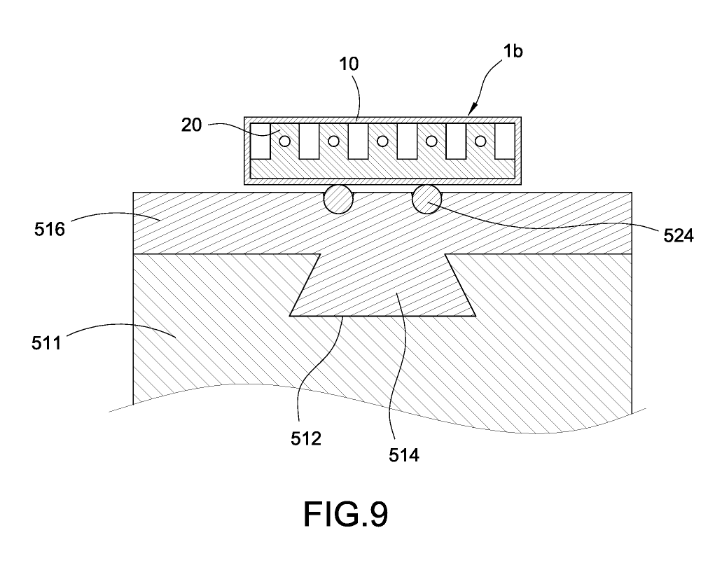

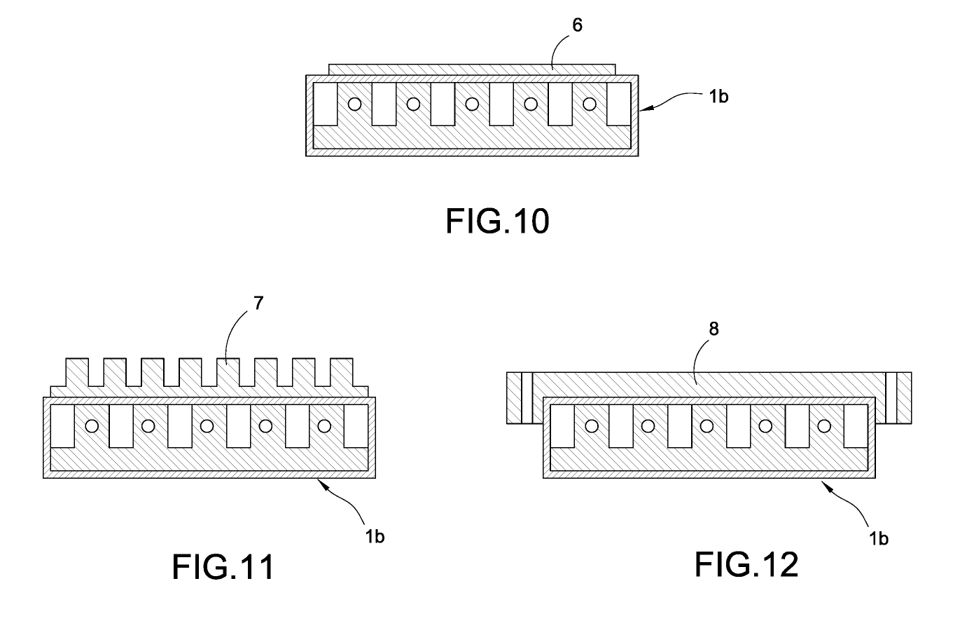

Preferably, the manufacturing method of the phase-changing heat dissipater provided by the present invention further includes a step f) which is processed after the step e), the step f) is to allow the metal powders to be provided and formed on an outer surface of the flat phase-changing heat dissipater 1b with another spraying means; please refer from FIG. 9 to FIG. 12, according to this step, a plate 516 is used for replacing the above-mentioned carrier 513, and the flat phase-changing heat dissipater 1b is disposed on each of the lower rollers 524 of the plate 516, and the above-mentioned upper roller 523 and the motor 522 are also adopted thereby enabling the flat phase-changing heat dissipater 1b to be left/right moved on the plate 516, and with the operation of the above-mentioned spraying mechanism 53, a heat conductive plate 6 to be sintered (as shown in FIG. 10), a plurality of heat dissipation sheets 7 (as shown in FIG. 11) or a fasten seat 8 (as shown in FIG. 12) can be respectively formed on the outer surface of the flat phase-changing heat dissipater 1b.

Preferably, the manufacturing method of the phase-changing heat dissipater provided by the present invention further includes a step g) which is processed after the step f), the step g) is to perform another sintering process to each of the metal powders for forming the heat conductive plate 6 (as shown in FIG. 10), the plural heat dissipation sheets 7 (as shown in FIG. 11) or the fasten seat 8.

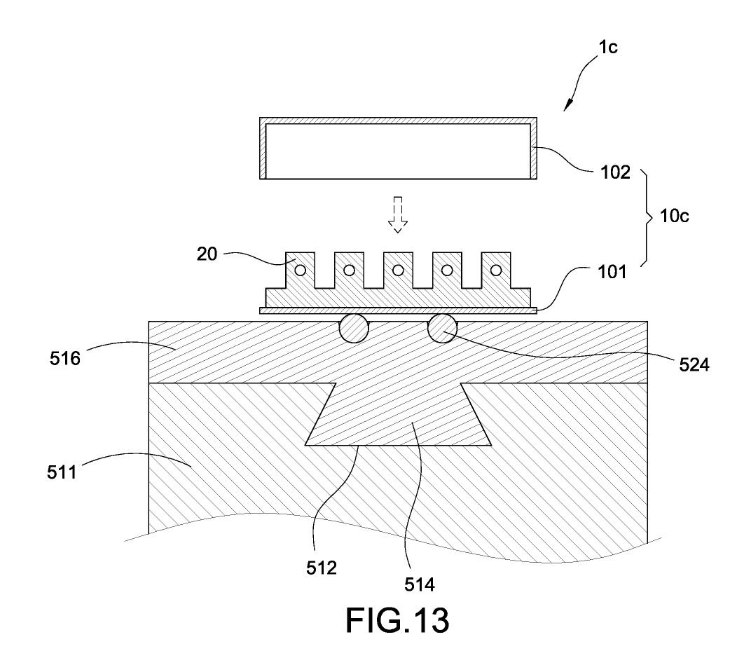

Please refer to FIG. 13, according to this embodiment, the phase-changing heat dissipater 1c is a vapor chamber, and a main body 10c thereof mainly includes a bottom plate 101 and a cover plate 102; the bottom plate 101 is disposed on each of the rollers 524 of the above-mentioned manufacturing equipment 5, and a driver (not shown in figures) is used for driving each of the rollers 524 so as to generate normal/reverse rotations, thereby allowing the bottom plate 101 to be reciprocally moved in a horizontal direction, and the above-mentioned spraying mechanism 53 is used for spraying metal powders on the top surface of the bottom plate 101, the laser head 541 of the above-mentioned sintering mechanism 54 is used for emitting laser to generate heat so as to sinter the metal powders thereby forming a capillary structure 20. After the manufacturing of the capillary structure 20 and the bottom plate 101 is finished, the cover plate 102 is correspondingly engaged and sealed with the bottom plate 101 with a soldering means, then a working fluid is filled in the main body 10c and a gas discharging and sealing operation is processed, thus the vapor chamber is formed.

Accordingly, the phase-changing heat dissipater and the manufacturing method thereof are novel and more practical in use comparing to prior arts.

Although the present invention has been described with reference to the foregoing preferred embodiment, it will be understood that the invention is not limited to the details thereof.

Various equivalent variations and modifications can still occur to those skilled in this art in view of the teachings of the present invention. Thus, all such variations and equivalent modifications are also embraced within the scope of the invention as defined in the appended claims.

What is claimed is:

1. A manufacturing method of a phase-changing heat dissipater, including:
step a) preparing a main body;
step b) allowing a plurality of metal powders to be provided and formed on an inner wall of the main body with a spraying means, and the inner wall for forming a three-dimensional capillary structure; and
step c) processing a sintering process to the three-dimensional capillary structure for forming a solid-state capillary structure.

2. The manufacturing method of the phase-changing heat dissipater according to claim 1, wherein the main body is a hollow tubular body, and the spraying means is achieved through circumferentially spraying the main body.

3. The manufacturing method of the phase-changing heat dissipater according to claim 1, wherein the main body is a hollow tubular body, and the spraying means is achieved through spraying the main body with an axially moving manner.

4. The manufacturing method of the phase-changing heat dissipater according to claim 1, wherein the spraying means disclosed in the step b) and the sintering process disclosed in the step c) are processed to the main body in stages.

5. The manufacturing method of the phase-changing heat dissipater according to claim 1, wherein the solid-state capillary structure is composed of a plurality of ribs, wherein a slot is formed between every two of the adjacent ribs, and each of the slots is formed in a spiral status.

6. The manufacturing method of the phase-changing heat dissipater according to claim 5, wherein a step d) is further provided after the step c), and the step d) is to fill a working fluid in the main body, and a gas discharging and sealing operation is processed.

7. The manufacturing method of the phase-changing heat dissipater according to claim 6, further including a step e), and the step e) is to perform a flattening process to the phase-changing heat dissipater for forming a flat phase-changing heat dissipater.

8. The manufacturing method of the phase-changing heat dissipater according to claim 7, further including a step f), and the step f) is to allow the metal powders to be provided and formed on an outer surface of the flat phase-changing heat dissipater with another spraying means.

9. The manufacturing method of the phase-changing heat dissipater according to claim 8, further including a step g), and the step g) is to perform another sintering process to each of the metal powders for forming a heat conductive plate, a plurality of heat dissipation sheets or a fasten seat.

10. The manufacturing method of the phase-changing heat dissipater according to claim 1, wherein the main body includes a bottom plate and a cover plate correspondingly engaged with the bottom plate, and the spraying means is achieved through spraying the bottom plate.
